(19) United States
(12) Patent Application Publication
(10) Pub. No.: US 2025/0174857 A1
(43) Pub. Date: May 29, 2025

(54) SEALED METAL-AIR BATTERY

(71) Applicant: ineova Corp., Akishima city, Tokyo (JP)

(72) Inventor: Masayuki Inokuchi, Akishima city, Tokyo (JP)

(73) Assignee: ineova Corp., Akishima city, Tokyo (JP)

(21) Appl. No.: 18/867,545

(22) PCT Filed: Jul. 27, 2022
(86) PCT No.: PCT/JP2022/028903

§ 371 Date: Nov. 20, 2024

(30) Foreign Application Priority Data
May 23, 2022 (JP) 2022-083987

(51) Int. Cl. H01M 50/618; H01M 10/6563; H01M 50/198; H01M 50/70

(52) U.S. Cl. CPC H01M 50/618; H01M 10/6563; H01M 50/198; H01M 50/70

(57) ABSTRACT

The purpose of the present invention is to realize a portable disaster prevention battery obtained by packaging, in a sealed container, a metal-air battery having high energy density. The sealed metal-air battery according to the present invention is a metal-air battery that uses metal in a negative electrode and an air electrode in a positive electrode and is provided with a sealed container accommodating the entire metal-air battery or at least a chemically reacting portion of the metal-air battery. The sealed container is a rigid metal container or a rigid resin container, and the inside of the sealed container during storage of the battery is in an atmospheric state or a vacuum state, or is an environment filled with an inert gas. During battery use, a portion of the sealed container is opened and an electrolytic solution is injected as to begin power generation. Alternatively, the inside of the sealed container during storage of the battery is in a state in which only the solute of electrolytic solution is accommodated therein, and during battery use, a portion of the sealed container is opened to inject the solvent of the electrolytic solution is injected to begin power generation.

### TECHNICAL FIELD

This invention relates to a sealed metal-air battery, specifically one used for portable disaster preparedness.

### BACKGROUND ART

Aluminum-air batteries, a typical type of metal-air battery, use aluminum as the negative electrode and an air electrode as the positive electrode. They have the characteristic of higher theoretical energy density compared to other types of batteries.

### PRIOR ART DOCUMENTS

### Patent Documents

Patent Document 1: JP2012-015025 “Aluminum-Air Battery” (published on Jan. 19, 2012), Applicant: Sumitomo Chemical Co., Ltd.
Patent Document 2: JP2014-194897 “Separator, Secondary Battery, and Method for Manufacturing Separator” (published on Oct. 9, 2014), Applicant: Hitachi Zosen Corporation

### SUMMARY OF THE INVENTION

### Problem to be Solved by the Invention

The present invention is directed to a metal-air battery. However, unless otherwise specified, the following description will be given taking an aluminum-air battery, which is a typical example of a metal-air battery, as an example.

Aluminum-air batteries, which can produce large amounts of electricity, have problems with self-discharge and heat generation when actually created, making them difficult to put into practical use. Several solutions have been proposed to the problems of self-discharge and heat generation, and the invention disclosed in Patent Document 1 is one of them.

Regarding the cylindrical shape of the air battery, for example, a shape similar to that described in Patent Document 2 has been proposed. The aim of Patent Document 2 is to suppress zinc dendrites. If the zinc disclosed here could be replaced with aluminum, a cylindrical aluminum-air battery could be realized.

It is necessary for the battery to be able to withstand long-term storage to use an aluminum-air battery as a disaster prevention battery. Furthermore, it is desirable for a disaster prevention battery to have a high energy density, be capable of supplying a large amount of power, be easy and safe to use, and be low cost.

Under the above circumstances, an object of the present invention is to realize a portable disaster prevention battery that utilizes a metal-air battery with high energy density.

### Means for Solving the Problem

The sealed metal-air battery of the present invention is, in one aspect, a sealed metal-air battery using a metal as the negative electrode and an air electrode as the positive electrode, comprising: a sealed container for housing the entire metal-air battery or at least the chemical reaction section, the sealed container being a rigid metal container or a rigid resin container; wherein during battery storage, the inside of the sealed container is in an atmospheric state, a vacuum state or an environment filled with an inert gas; and when the battery is to be used, at least part of the sealed container is opened to an inject electrolytic solution thereinto to begin power generation.

Furthermore, the sealed metal-air battery according to the present invention is, in one aspect, a sealed metal-air battery using a metal as the negative electrode and an air electrode as the positive electrode, comprising: a sealed container for housing the entire metal-air battery or at least the chemical reaction section, the sealed container being a flexible metal container, a flexible metal container coated with a resin film or a flexible resin container; wherein during battery storage, the inside of the sealed container is in an atmospheric state, a vacuum state or an environment filled with an inert gas; and when the battery is to be used, at least part of the sealed container is opened to inject an electrolytic solution thereinto to begin power generation.

Furthermore, the sealed metal-air battery according to the present invention is, in one aspect, A sealed metal-air battery using a metal as the negative electrode and an air electrode as the positive electrode, comprising: a sealed container for housing the entire metal-air battery or at least the chemical reaction section, the sealed container being a rigid metal container or a rigid resin container; wherein during battery storage, the inside of the sealed container contains only the solute of the electrolytic solution; and when the battery is to be used, at least part of the sealed container is opened to inject a solvent for the electrolytic solution thereinto to begin power generation.

Furthermore, the sealed metal-air battery according to the present invention is, in one aspect, a sealed metal-air battery using a metal as the negative electrode and an air electrode as the positive electrode, comprising: a sealed container that contains the entire metal-air battery or at least the chemical reaction part fixed on a support, said sealed container being a flexible metal container, a flexible metal container with a resin coating, or a flexible resin container; wherein during battery storage, the inside of the sealed container contains only the solute of the electrolytic solution; and when the battery is to be used, at least part of the sealed container is opened to inject a solvent for the electrolytic solution thereinto to begin power generation.

Furthermore, in the above sealed metal-air battery, the inside of the sealed container may be in a vacuum state or an environment filled with an inert gas, with only the solute of electrolytic solution contained therein during storage of the battery.

Furthermore, in the above metal-air battery, the negative electrode may use a metal selected from the group consisting of aluminum, magnesium, zinc, calcium, and iron, or an alloy containing such a metal.

Furthermore, in the above sealed metal-air battery, the negative electrode may be made of an extruded or drawn metal material.

Furthermore, in the above sealed metal-air battery, the electrolytic solution inside the metal-air battery may be structured to circulate through a reaction section in the can container by natural convection or forced convection.

Furthermore, in the above sealed metal-air battery, the battery may comprise fan motor, a temperature sensor and a control circuit for controlling them, wherein the electrolytic solution inside the metal-air battery is forced to cool by the fan motor.

Furthermore, in the above sealed metal-air battery, the control circuit mat control the rotation speed of the fan motor through feedback control based on the detected temperature with the temperature sensor, thereby maintaining the temperature of the chemical reaction section within an appropriate range and suppressing thermal runaway due to reaction heat.

### Effects of the Invention

This invention enables the realization of a high energy-density metal-air battery packed into a sealed container for use in portable disaster prevention battery.

### BRIEF DESCRIPTION OF DRAWINGS

FIG. 1 is a diagram illustrating a reaction section of a sealed aluminum-air battery according to this embodiment.

FIG. 2 is a diagram illustrating the overall structure of the sealed aluminum-air battery shown in FIG. 1.

FIG. 3 shows a block diagram of an electronic circuit board of the sealed aluminum-air battery according to this embodiment.

FIG. 4 is a characteristic diagram of output voltage vs. output power in the sealed aluminum-air battery according to this embodiment.

### EMBODIMENTS FOR IMPLEMENTING THE INVENTION

Hereinafter, an embodiment of a sealed metal-air battery according to the present invention will be described in detail with reference to the accompanying drawings, taking as an example an aluminum-air battery housed in a cylindrical can container, unless otherwise specified. In the drawings, the same reference numerals are given the same reference numerals and redundant explanations are omitted.

[Overview of the Sealed Aluminum-Air Battery of this Embodiment]

In this embodiment, during storage, the sealed aluminum-air battery of this embodiment is packed into a sealed container in a state where no chemical reaction occurs, with the entire battery or at least the reaction part of the battery being sealed in a sealed container. The chemical reaction only begins when the battery is used, and electricity is extracted while being controlled to maintain optimal conditions.

### First Embodiment

### (Construction)

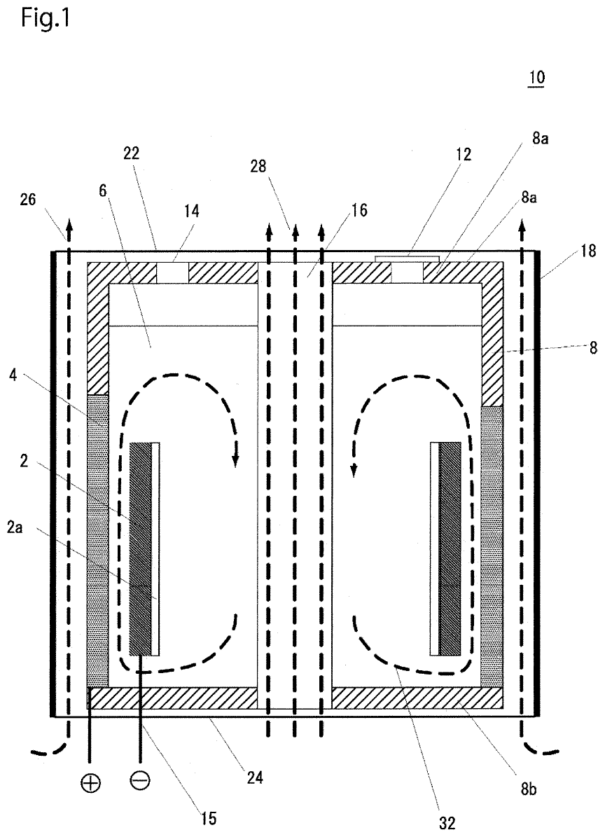

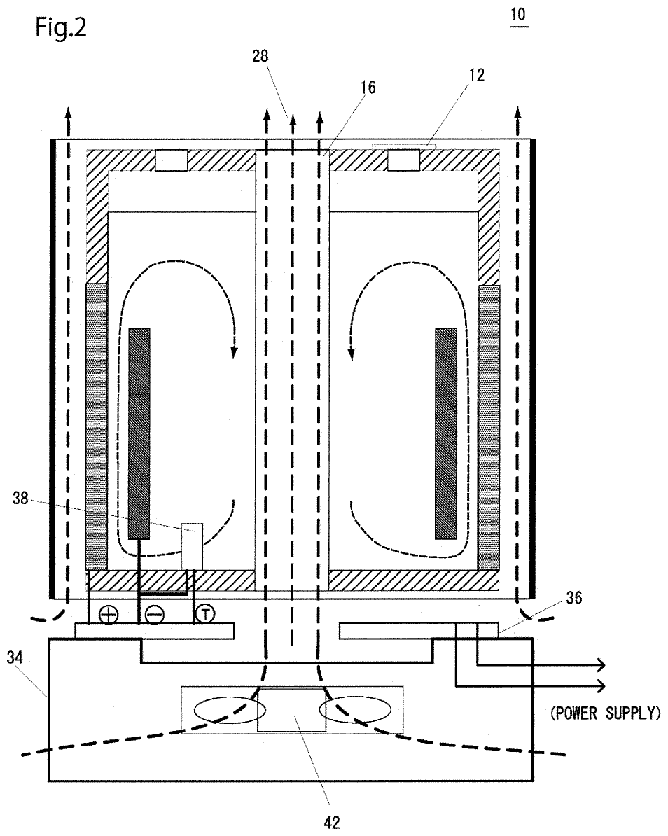

FIG. 1 shows the reaction section of a sealed aluminum air battery 10 according to this embodiment. FIG. 2 shows the overall structure of a sealed aluminum-air battery 10. As shown in FIG. 1, the chemical reaction section of an aluminum-air battery 10 is composed of a cylindrical negative electrode 2, a cylindrical positive electrode (air electrode) 4, an electrolytic solution 6, and a sealing frame 8 that seals them.

The cylindrical negative electrode 2 is made of aluminum, with an anti-corrosion coating 2a applied to its inner surface. The sealing frame 8 is equipped with a gas venting film 12, a water supply port 14, and a cooling pipe 16.

These components are all housed inside a cylindrical can 18, and a top cover or lid 22 and a bottom cover or lid 24 are attached to the top and bottom edges of the cylindrical can 18, respectively. The cylindrical can 18 and the these lids 22, 24 are made of a metal such as steel, aluminum, or stainless steel. In this application document, this structure will be referred to as a “sealed battery.” Each of the lids 22, 24 is constructed to keep the cylindrical can 18 sealed, and is also constructed so that all or part of it can be easily removed. For example, all of the removal structures are achieved by removing a pull-top portion in top or bottom lid, and some of the removal structures are achieved by peeling off an aluminum seal covering an opening in top or bottom lid.

Before use, the inside of the sealed can container is kept in a state where no chemical reaction occurs by, for example;
(1) maintaining a vacuum,
(2) filling it with an inert gas (preferably nitrogen gas),
(3) filling it with only the solute of the battery electrolytic solution, or
(4) filling it with only the solute of the battery electrolytic solution and using either the above (1) or (2) in combination.

These methods prevent the battery materials stored inside from oxidizing or deteriorating, making it possible to store the battery for a long period of time

It is preferable to fill the can with nitrogen gas (i.e. an inert gas) in advance. If the sealing of the can is made in the atmosphere, an active gas such as oxygen inside the can will substantially react with the electrode material, so that the inside of the can will filled with the remaining inert gas such as nitrogen gas or argon gas.

Furthermore, in the above (1) to (4), it is preferable to enclose in the can a getter material (gas adsorbent) made of an iron-based deoxidizer or an alloy of Ti, Zr, Al, or the like, in order to adsorb any leaked unwanted gases, thereby enabling the battery to be maintained for a long period of time.

When the battery is in use, in the above (1) and (2), part of the can is opened and the electrolytic solution is injected into the can, and in the above (3) and (4), the solvent of electrolytic solution (i.e. water) is injected into the can to generate the electrolytic solution thereby. This allows the battery to start generating electricity for the first time when it is used.

In FIG. 1, the air flow 26 supplied to the air electrode 4, the air flow 28 for cooling the electrolyte 6, and the convection flow 32 of the electrolyte 6 are each shown by dashed lines when the top cover 22 or bottom cover 24 is removed.

The structure of the reaction section of this sealed battery can basically be realized by accommodating a cylindrical aluminum negative electrode 2 and a cylindrical positive electrode (air electrode) 4 within a sealing frame 8 and by sandwiching them between a circular top lid 8a and a circular bottom lid 8b from above and below.

The sealing frame 8 and the circular top and bottom plates 8a and 8b can be made of resin materials, such as ABS, polyethylene, or polypropylene.

The cylindrical negative electrode 2, made of aluminum, can be produced from mass-manufactured aluminum pipes, reducing material costs.

The cooling pipe 16 can be made of commercially available stainless steel or aluminum pipes, enhancing heat dissipation and strength. If aluminum pipes are used, anti-corrosion coating is necessary to prevent corrosion from the electrolytic solution.

The cylindrical canister 18 and the lids 22, 24 can use mass-produced cans to reduce material costs.

### (Operation)

As shown in FIG. 1, in a sealed battery 10, when viewed in a cross section parallel to the circular top plate 8a and bottom plate 8b, the cylindrical aluminum negative electrode 2 is positioned inside, and the positive electrode of air 4 is positioned outside the negative electrode 2. When the electrolytic solution 6 is filled between the negative electrode 2 and the positive electrode 4, power generation begins. Structurally, by providing a gap between the negative electrode 2 and the positive electrode 4, the negative electrode 2 and the positive electrode 4 are prevented from short-circuiting each other, and therefore a separator can be omitted.

The electrolytic solution 6 is injected into the can at the time of use in the above (1) or (2), and it is created by pouring water into the solute filled within the can in the above (3) or (4). Caustic soda and caustic potash are mainly used as the solute. When power generation begins, the electrolytic solution 6 in the sealed battery is heated by the heat of reaction and cooled by the cooling pipe 16, generating convection 32 as shown in the Figure. Due to this convection 32, fresh electrolytic solution 6 is always supplied between the positive electrode 4 and the negative electrode 2.

When the positive and negative electrodes are arranged in this manner and filled with an electrolytic solution having the electrolyte concentration of 8-20 wt %, a current of 50-100 mA/cm² is generated. Since the electrodes are arranged around the peripheral area within the can, the surface areas of the positive and negative electrodes can be made large, making it possible to generate a large output continuously. An extraction electrode 15 is provided on each of the positive electrode 4 and the negative electrode 2, and when power generation begins, electricity can be extracted through the extraction electrode 15.

Gas-permeable film 12 does not allow electrolytic solution 6 to pass therethrough, and allow only releases gas (mainly hydrogen gas) which generated by the reaction to pass through it to the outside. The gas venting film 12 may be made of a porous polyethylene sheet, a porous Teflon (registered trademark) sheet, or the like. By using the gas-permeable film 12, the battery can be sealed by closing the water inlet 14 after water is supplied. By making the battery sealed, leakage of electrolyte can be prevented in the event of a fall. By covering the outer periphery of the aluminum-air battery with a can container having high mechanical strength, it is possible to prevent the electrolytic solution 6 from leaking out of the battery even if it is accidentally dropped or stepped on.

### Second Embodiment

### (Construction)

FIG. 2 shows the overall structure of a sealed aluminum-air battery 10. As shown in FIG. 2, by placing the reaction section of the sealed battery 10 on a support stand 34, the lead electrodes 15 of the sealed battery can be easily connected to the power supply terminals (+) and (−) of an electronic circuit board 36 on the support stand 34.

The temperature of the electrolytic solution 6 is detected by a temperature sensor 38 installed within the electrolytic solution 6. In order to reduce the number of terminals to be connected, one terminal of the temperature sensor 38 may be connected to the negative electrode 2 and the other may be connected to the temperature detection terminal (T) of the electronic circuit board 36. The temperature sensor 38 may be, for example, a thermocouple or a thermistor.

A fan motor 42 is installed on the support base 34. By rotating the fan motor 42, air can be sent into the cooling pipe 16, forcing the electrolytic solution 6 to be cooled. Generally, the fan motor 42 can change the rotation speed of the fan by changing the voltage applied to the fan motor 42, and therefore, by increasing the power supply voltage to the fan motor 42, it is possible to improve the cooling effect. Furthermore, fan motors 42 whose rotation speed is controlled by an external PWM signal, such an motor is also commercially available. In this example, a fan motor 42 with a PWM control function is used.

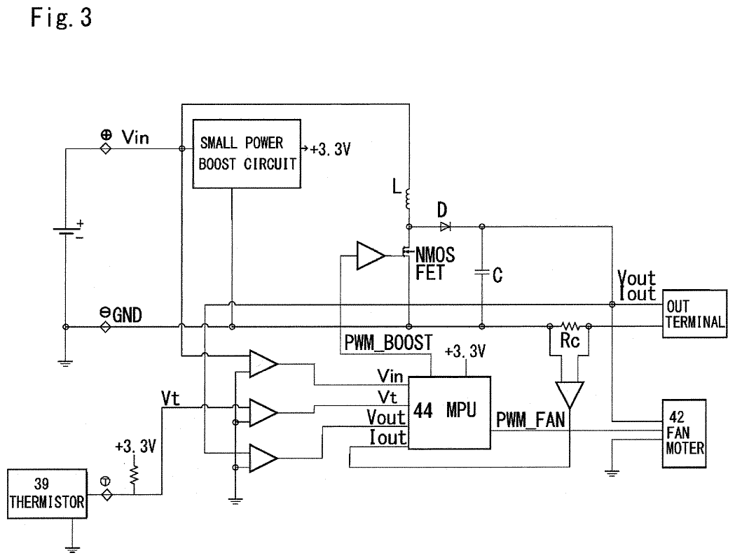

FIG. 3 shows a block diagram of the electronic circuit board 36. Since the output voltage of the power generating cell is as low as 1.7V, it is boosted to +3.3V by a small power boost circuit in order to drive the MPU 44 and other devices. Overall control is performed by the MPU 44. The input voltage Vin, the temperature Vt of the electrolytic solution 6, the output voltage Vout, and the output current Iout are input to the MPU 44, and they each are converted into digital data by an ADC (A/D converter) within the MPU 44.

The MPU 44 reads these data and outputs PWM_BOOST and PWM_FAN of PWM signals. PWM_BOOST controls the gate of an NMOS FET via a gate driver.

The MPU 44 is capable of controlling the output current Iout, the output voltage Vout, the rotation speed of the fan motor 42, and the like. The fan motor 42 adjusts the volume of the cooling air by changing the pulse width (PWM) thereby controlling the temperature of the electrolytic solution 6 as described above.

### (Operation)

The sealed battery 10 is composed by a single-cell aluminum-air battery, whose open-circuit electromotive force is approximately 1.5-1.7V. The electromotive force output from the power supply terminal is converted to a required voltage by a boost circuit mounted on the electronic circuit board 36. The boost circuit is composed of a coil L, an NMOS FET, a diode D, and a smoothing capacitor C shown in FIG. 3.

In general, the output voltage Vout is often used at a predetermined fixed value. For example, the voltage is boosted to 5.0V to supply it to a USB terminal.

The MPU 44 outputs PWM_BOOST based on the input Vout and Iout, and drives the gate of the NMOS FET through the gate driver with these signals, thereby boosting Vin to Vout.

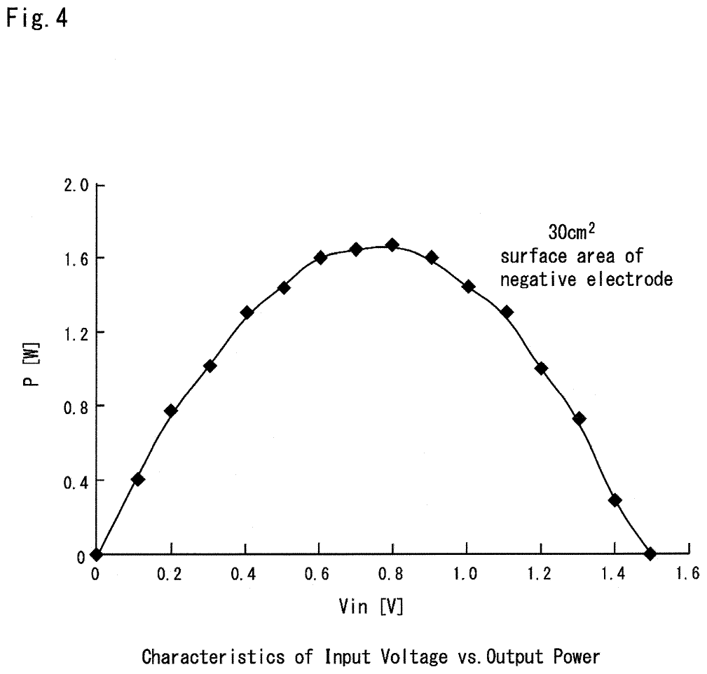

FIG. 4 shows the experimental characteristics of the sealed aluminum-air battery 10 according to this embodiment, showing the input voltage Vin [V] versus output power P(=Vout×Iout) [W]. As shown in the Figure, the output power exhibits a bell-shaped characteristic, peaking when Vin is around 0.7-0.8V. At Vin=0 or 1.4V (open circuit voltage), it is approximately zero. Therefore, as long as the output is limited so that Vin does not drop below approximately 0.8V, the battery will react with Vin approximating the open-circuit voltage of 1.5V (open circuit voltage) when the output power is low and will react with Vin around 0.8V when the output power is high, similarly to a conventional battery.

The MPU 44 can control Pout by controlling the width of the PWM_BOOST signal within the range of the characteristics shown in FIG. 4. Alternatively, it is also possible to control Vout to be constant.

Reaction heat is generated during power generation. This reaction heat promotes power generation, but also accelerates side reactions that do not contribute to power generation, resulting in increased reaction heat. At this time, if the heat of reaction exceeds a certain temperature, a thermal runaway phenomenon occurs in which the reaction is accelerated due to the heat of reaction, and the temperature may rise suddenly, to potentially cause the electrolytic solution 6 to boil.

According to experiments, if the electrolytic solution 6 exceeds 50° C., it deteriorates, hindering power generation. In such cases, there is a risk of burns if a finger or the like come into contact with the sealed aluminum-air battery 10, so it is desirable to control the temperature of the electrolytic solution 6 so that it does not exceed 50° C. The control circuit measures the temperature with the temperature sensor 38 and adjusts the rotation speed of the fan motor 42 through feedback control to maintain the electrolytic solution 6 temperature below 50° C.

### Advantages and Effects of these Embodiments

(1) During storage, the sealed aluminum-air battery of this embodiment is packed into a can container in a state where the entire battery or at least the chemically reactive part of the battery is not undergoing any reaction. When in use, reactions are initiated, and then controlled to continue under optimal conditions, producing electricity.

Specifically, before use, the inside of the sealed can container is kept in a state where no chemical reaction occurs by, for example,
(i) maintaining a vacuum,
(ii) filling it with an inert gas (preferably nitrogen gas),
(iii) filling it with only the solute of the battery electrolyte, or
(iv) filling it with only the solute of the battery electrolyte and using either (1) or (2) in combination.

When the battery is in use, in cases (1) and (2), part of the can is opened to inject electrolytic solution thereinto, and in cases (3) and (4), the solvent of electrolytic solution (water) is injected thereinto to generate the electrolytic solution inside the can.

This feature suppresses the occurrence of chemical reactions inside the battery during storage, allowing the battery to withstand long-term storage. The chemical reaction and power generation start only when it is put into use. According to this embodiment, by adopting these construction, the following effects are achieved.

(2) It is possible to realize a portable disaster prevention battery that uses an aluminum-air battery with high energy density.

(3) The entire aluminum-air battery or its chemical reaction part is packed into a sealed can container during storage, making it convenient to carry. Furthermore, the battery is firmly resistant to an external impact and can be stored in a perfect condition.

(4) Can containers may be of any shape and size commonly used for cans. This makes it easy to handle. By stacking multiple can containers, multiple batteries can be stored compactly.

(5) Mass-produced aluminum round pipes and square pipes can be used for the aluminum electrode material, which reduces costs.

(6) The separator between the positive and negative electrodes that is required in conventional air batteries can be eliminated, and the number of parts can be reduced, resulting in lower costs.

### Variations and Others

As described above, embodiments of the sealed metal-air battery according to the present invention have been explained using an aluminum-air battery as an example. However, these embodiments are merely examples of the present invention and do not limit the present invention in any way. Further there is a third embodiment of the sealed metal-air battery according to the present invention.

### Third Embodiment

The sealed metal-air battery of the present invention can take various forms, mainly with regard to the type of container, the state inside the container during storage (before the chemical reaction) and at the start of use (during the chemical reaction), and the like.

(1) Container types:

The type of container used to enclose the battery may be any of the followings:

### (A) Rigid Metal Container:

In addition to the can container 18 described in embodiments 1 and 2, rigid metal containers such as tinplate, steel, aluminum, etc. can be used.

### (B) Rigid Resin Container:

Rigid resin containers, such as those made from ABS, polyethylene, polypropylene, or PET, can be manufactured inexpensively via injection molding. To enhance airtightness and rustproof properties to these cans, these cans can be plated or vapor-deposited with metals like zinc or aluminum, or coated with high gas-barrier resins like PET or PGA.

Furthermore, by arranging the electrode components beforehand during the injection molding process and integrating them into the resin, the cost of assembling components like the bottom plate 8b, cylindrical positive electrode 4, and cylindrical negative electrode 2 can be reduced.

### (C) Flexible Metal Container:

Since the container is flexible, at least one of the electrodes (positive or negative) is fixed to a rigid support (e.g., bottom plate 8b). This rigid support can be made from metal, non-metallic materials (e.g., resin, ceramic, cement, fibers), or composite materials. The entire battery or reaction section is sealed in a flexible metal container, such as a metal foil like aluminum foil.

### (D) Resin-Coated Flexible Metal Container:

Similarly, the battery is fixed with a rigid support. The entire battery or reaction section is sealed within a flexible metal container coated with resin (e.g., a laminated film made of aluminum foil coated with a resin such as PET or PP resin).

### (E) Flexible Resin Container:

Similarly, at least one of the positive and negative electrodes is fixed to a rigid support. The entire battery or the reaction section is sealed in a flexible resin container (for example, a laminate film formed by laminating PET resin, acrylic resin, or the like).

(2) Condition inside the container during storage (before the chemical reaction) and at the start of use (during the chemical reaction):
(a) (during storage) atmospheric air, i.e. air, and (at the start of use) an electrolytic solution is added.
(b) (during storage) in a vacuum state, and (when first used) electrolyte is added.
(c) (during storage) it is filled with an inert gas, such as nitrogen gas, and (when first used) an electrolytic solution is added.
(d) (during storage) only the solute of electrolytic solution filled, and (when first used) a solvent, for example water, is added.
(e) (during storage) only the solute of electrolytic solution is filled under any of the conditions (a) to (c), and (at the start of use) a solvent, for example water, is added.

(3) The type of container in (1) and the state inside the container during storage and at the start of use in (2) can be arbitrarily combined as shown in Table 1 as a third embodiment.

TABLE 1

| | (a) | (b) | (c) | (d) | (e) |
|---|---|---|---|---|---|
| | atmosphere | vacuum | inert gas | solute | solute, (a-c) |
| | addition of | addition of | addition of | addition | addition |
| | electrolytic | electrolytic | electrolytic | of | of |
| | solution | solution | solution | solvent | solvent |
| (A) rigid | the first | the first and second | | | the third |
| metal | embodiment | embodiments | | | embodiment |
| containers | | | | | |
| (B) rigid | the third embodiment | | | | |
| resin | | | | | |
| containers | | | | | |
| (C) flexible | | | | | |
| metal | | | | | |
| containers | | | | | |
| (D) resin- | | | | | |
| coated | | | | | |
| flexible | | | | | |
| metal | | | | | |
| container | | | | | |
| (E) flexible | | | | | |
| resin | | | | | |
| container | | | | | |

(4) Use of metals other than aluminum for the negative electrode:

In this embodiment, aluminum is used as the negative electrode metal; however, any metal (i.e. magnesium, zinc, calcium, iron, and their alloys) that reacts with the electrolyte and ionizes can be used as the negative electrode material. For example, when magnesium is used as the negative electrode metal, sodium chloride or potassium hydroxide solutions can be used as the electrolyte. When zinc is used as the negative electrode metal, potassium hydroxide solution can be used. If iron is used, an alkaline solution can be used as the electrolyte.

However, in general, these metals have lower theoretical energy densities, which makes them less favorable for achieving a large electric capacity compared to aluminum. Aluminum is advantageous not only because it has the highest theoretical volumetric energy density but also because it is safe, inexpensive, and abundant in resources on Earth.

(5) Other uses beyond disaster prevention:

Although this invention is described for use in disaster prevention, it is not limited to such applications. For example, it can be used as a battery for distress signals or for recreational purposes, just as a general-purpose battery.

(6) Solvent of the electrolytic solution:

In this example, water has been used as an example of the solvent for the electrolytic solution, but the solvent may also be wastewater or seawater, and the electrolytic solution may be not only aqueous but also ionic liquid. Furthermore, in addition to pouring in water, if the container is held in a vacuum state, water may be absorbed when the container is opened. This function is useful in cases where the battery is automatically activated when it contacts water, such as when a life jacket inflates when submerged.

(7) Battery shape:

This invention is described with a cylindrical shape viewed from the top; however, the battery can be shaped in any desired form, including polygons or polygons with curves. Similarly, the negative electrode does not have to be cylindrical; it could also be flat or rod-shaped. By making the negative electrode thick and hollow in the center, it could also function as an air-cooling pipe. Even with such complex shapes, it can be manufactured at low cost using metal extrusion or drawing methods. Although the surface area of the positive electrode may decrease, it could be placed inside and used as a combined fan pipe.

(8) Cooling of the electrolytic solution:

The convection of the electrolytic solution 6 is described as natural convection, but forced convection using a fan motor 42 or other devices could also be employed. Forced cooling using a fan motor is employed in this embodiment; however, by increasing the size of the cooling pipe 16 or adding folds to improve heat dissipation efficiency, the fan motor 42 could be removed. Additionally, by structuring the exterior of the can for cooling, the need for cooling pipes could be reduced. Forced cooling by the fan motor 42 can help maintain the sealed aluminum air battery at an optimal temperature for efficient power generation, extending the battery's operation time.

(9) Others:

Additions, deletions, modifications, or improvements related to embodiments that can be easily carried out by those skilled in the art are within the scope of this invention. The technical scope of the invention is determined by the descriptions in the appended claims.

### EXPLANATION OF REFERENCE NUMERALS

10: sealed aluminum air battery, 2: cylindrical negative electrode, 2a: rust-resistant coating, 4: positive electrode, cylindrical positive electrode, air electrode, 6: electrolytic solution, 8: sealing frame, 8a: top plate, 10: sealed aluminum air-battery, aluminum air-battery, air-battery, 12: gas release film, 14: water absorption port, 15: output electrode, 16: cooling pipe, 22: top lid, 18: cylindrical can, 24: bottom lid, 28: air flow, 32: convective flow, 34: support base, 36: electronic circuit board, 38: temperature sensor, 42: fan motor, 44: MPU

1. A sealed metal-air battery using a metal as the negative electrode and an air electrode as the positive electrode, comprising: a sealed container for housing the entire metal-air battery or at least the chemical reaction section, the sealed container being a rigid metal container or a rigid resin container;
wherein during battery storage, the inside of the sealed container is in an atmospheric state, a vacuum state or an environment filled with an inert gas; and when the battery is to be used, at least part of the sealed container is opened to inject electrolytic solution thereinto to begin power generation.

2. A sealed metal-air battery using a metal as the negative electrode and an air electrode as the positive electrode, comprising: a sealed container for housing the entire metal-air battery or at least the chemical reaction section, the sealed container being a flexible metal container, a flexible metal container coated with a resin film or a flexible resin container;
Wherein during battery storage, the inside of the sealed container is in an atmospheric state, a vacuum state or an environment filled with an inert gas; and when the battery is to be used, at least part of the sealed container is opened to inject electrolytic solution thereinto to begin power generation.

3. A sealed metal-air battery using a metal as the negative electrode and an air electrode as the positive electrode, comprising: a sealed container for housing the entire metal-air battery or at least the chemical reaction section, the sealed container being a rigid metal container or a rigid resin container;
wherein during battery storage, the inside of the sealed container contains only the solute of the electrolytic solution; and when the battery is to be used, at least part of the sealed container is opened to inject a solvent for the electrolytic solution thereinto to begin power generation.

4. A sealed metal-air battery using a metal as the negative electrode and an air electrode as the positive electrode, comprising: a sealed container that contains the entire metal-air battery or at least the chemical reaction part fixed on a support, said sealed container being a flexible metal container, a flexible metal container with a resin coating, or a flexible resin container;
wherein during battery storage, the inside of the sealed container contains only the solute of the electrolytic solution; and when the battery is to be used, at least part of the sealed container is opened to inject a solvent for the electrolytic solution thereinto to begin power generation.

5. A sealed metal-air battery as claimed in claim 3,
wherein the inside of the sealed container is in a vacuum state or an environment filled with an inert gas, with only the solute of the electrolytic solution contained therein during storage of the battery.

6. A sealed metal-air battery according to claim 1, wherein the negative electrode uses a metal selected from the group consisting of aluminum, magnesium, zinc, calcium, and iron, or an alloy containing such a metal.

7. (canceled)

8. A sealed metal-air battery according to claim 1, wherein the electrolytic solution inside the metal-air battery is structured to circulate through a reaction section in the can container by natural convection or forced convection.

9. A sealed metal-air battery as claimed in claim 1, further comprising;
a fan motor, a temperature sensor and a control circuit for controlling them, wherein the electrolytic solution inside the metal-air battery is forced to cool by the fan motor.

10. (canceled)

11. A sealed metal-air battery as claimed in claim 4,
wherein the inside of the sealed container is in a vacuum state or an environment filled with an inert gas, with only the solute of the electrolytic solution contained therein during storage of the battery.

12. A sealed metal-air battery according to claim 2, wherein the negative electrode uses a metal selected from the group consisting of aluminum, magnesium, zinc, calcium, and iron, or an alloy containing such a metal.

13. A sealed metal-air battery according to claim 3, wherein the negative electrode uses a metal selected from the group consisting of aluminum, magnesium, zinc, calcium, and iron, or an alloy containing such a metal.

14. A sealed metal-air battery according to claim 4, wherein the negative electrode uses a metal selected from the group consisting of aluminum, magnesium, zinc, calcium, and iron, or an alloy containing such a metal.

15. A sealed metal-air battery according to claim 2, wherein the electrolytic solution inside the metal-air battery is structured to circulate through a reaction section in the can container by natural convection or forced convection.

16. A sealed metal-air battery according to claim 3, wherein the electrolytic solution inside the metal-air battery is structured to circulate through a reaction section in the can container by natural convection or forced convection.

17. A sealed metal-air battery according to claim 4, wherein the electrolytic solution inside the metal-air battery is structured to circulate through a reaction section in the can container by natural convection or forced convection.

18. A sealed metal-air battery as claimed in claim 2, further comprising;
a fan motor, a temperature sensor and a control circuit for controlling them, wherein the electrolytic solution inside the metal-air battery is forced to cool by the fan motor.

19. A sealed metal-air battery as claimed in claim 3, further comprising;
a fan motor, a temperature sensor and a control circuit for controlling them, wherein the electrolytic solution inside the metal-air battery is forced to cool by the fan motor.

20. A sealed metal-air battery as claimed in claim 4, further comprising;
a fan motor, a temperature sensor and a control circuit for controlling them, wherein the electrolytic solution inside the metal-air battery is forced to cool by the fan motor.

21. A sealed metal-air battery as described in claim 19,
wherein the control circuit controls the rotation speed of the fan motor through feedback control based on the detected temperature with the temperature sensor, thereby maintaining the temperature of the chemical reaction section within an appropriate range and suppressing thermal runaway due to reaction heat.

22. A sealed metal-air battery as described in claim 20,
wherein the control circuit controls the rotation speed of the fan motor through feedback control based on the detected temperature with the temperature sensor, thereby maintaining the temperature of the chemical reaction section within an appropriate range and suppressing thermal runaway due to reaction heat.
